(19) United States
(12) Patent Application Publication
(10) Pub. No.: US 2012/0250735 A1
(43) Pub. Date: Oct. 4, 2012

(54) X2 Form Factor 10GBASE-T Transceiver Module

(75) Inventors: Norman Tang, Los Altos, CA (US); Liang Ping Peng, Santa Clara, CA (US); David Lai, Mountain View, CA (US); Anthony Nguyen, San Jose, CA (US)

(73) Assignee: CISCO TECHNOLOGY, INC., San Jose, CA (US)

(21) Appl. No.: 13/074,613

(22) Filed: Mar. 29, 2011

(51) Int. Cl. H04B 1/38

(52) U.S. Cl. 375/219

(57) ABSTRACT

An apparatus includes a transceiver device mounted on a printed circuit board and configured to transmit and receive signals that comply with a 10GBASE-T standard. A pluggable connector is disposed at one end of the printed circuit board and is coupled to the transceiver device. The pluggable connector is configured to plug into an X2 system port to convey signals that comply with the 10GBASE-T standard between the transceiver device and a system device. A port device is disposed at an opposing end of the printed circuit board and is coupled to the transceiver device. The port device is configured to receive a transmission cable to convey signals that comply with the 10GBASE-T standard between the transceiver device and a network device.

### TECHNICAL FIELD

The present disclosure generally relates to an X2 form-factor pluggable transceiver operable at increased rates of data transmission.

### BACKGROUND

The Institute of Electrical and Electronic Engineers (IEEE) sets forth standards for particular rates of data transmission. For example, IEEE 802.3an describes a 10GBASE-T standard for transmission of data at a nominal rate of 10 Gigabits per second over unshielded or shielded twisted-pair cables, over distances of up to 100 meters. The main objective of the 10GBASE-T standard is to provide a cost effective and highly scalable 10 Gigabit Ethernet implementation over structured copper cabling infrastructure that is widely used in data centers. X2 form-factor pluggable devices allow for connectivity of customers over a system infrastructure via a pluggable connection.

### BRIEF DESCRIPTION OF THE DRAWINGS

FIG. 1 is an exploded perspective view of an example of an X2 form factor module configured to convey 10GBASE-T standard data signals between a system device and a network device.

FIGS. 2A and 2B are perspective views showing an example of a fully assembled 10GBASE-T X2 module.

FIG. 3 is a block diagram depicting examples of functional components of the 10GBASE-T X2 module.

FIG. 4 is a diagram depicting examples of functionality of the 10GBASE-T X2 module in relation to the ISO OSI reference model.

FIG. 5 is a perspective view showing the structure of the port device of the 10GBASE-T X2 module.

FIG. 6 is an example of a functional flow diagram illustrating a process for operating a 10GBASE-T X2 module.

FIG. 7 is an example of a functional flow diagram illustrating a process for manufacturing a 10GBASE-T X2 module.

### DESCRIPTION OF EXAMPLE EMBODIMENTS

### Overview

An apparatus is provided comprising a printed circuit board and a transceiver device mounted on the printed circuit board and configured to transmit and receive signals that comply with a 10GBASE-T standard. A pluggable connector is disposed at one end of the printed circuit board and is coupled to the transceiver device. The pluggable connector is configured to plug into a pluggable X2 port of a system device to convey signals that comply with the 10GBASE-T standard between the transceiver device and the system device. A port device is disposed at an opposing end of the printed circuit board and is coupled to the transceiver device via the printed circuit board. The port device is configured to receive a transmission cable to convey signals that comply with the 10GBASE-T standard between the transceiver device and a network device.

### Example Embodiments

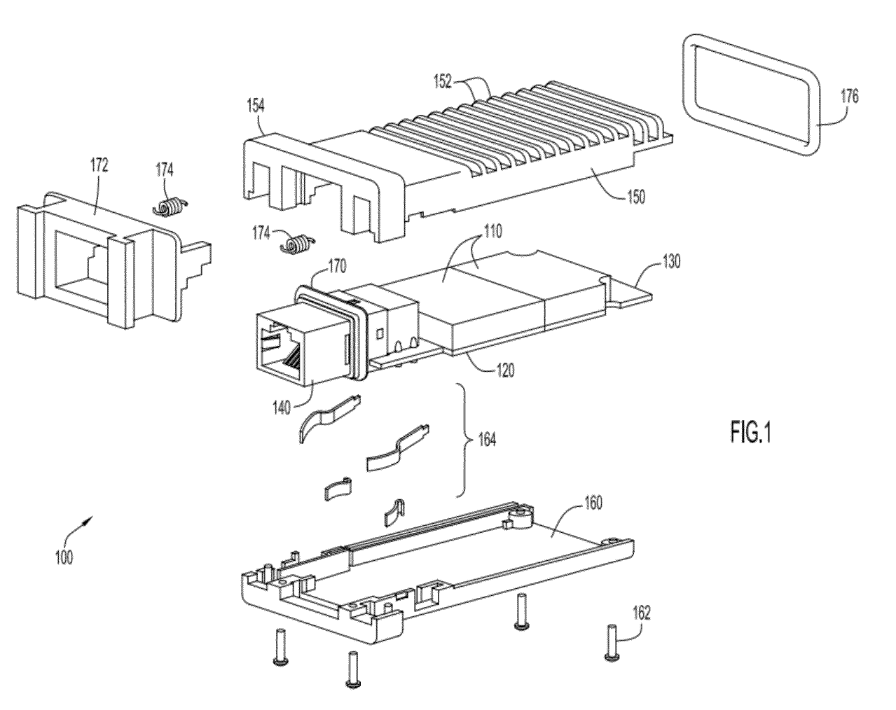

FIG. 1 is an exploded perspective view of a 10GBASE-T X2 form factor module 100 showing the major internal and external components of the module. One or more integrated circuit chips constituting a transceiver device 110 are mounted on a multi-layer printed circuit board 120 that provides electrical signal paths between transceiver device 110 and external connectors. Transceiver device 110 is configured to transmit and receive signals that comply with a 10GBASE-T standard between a system device and a network device.

A pluggable connector 130 conforming to the X2 form factor is disposed at one longitudinal end of printed circuit board 120 and comprises a transversely extending row of conductive contact pins or pads along the edge of printed circuit board 120. Pluggable connector 130 is configured to be slidably inserted into a system port or socket conforming to the X2 form factor to convey 10GBASE-T signals between one or more system devices and transceiver device 110.

Printed circuit board 120 provides electrical signal paths between transceiver device 110, pluggable connector 130 and a port device 140 disposed at an opposing longitudinal end of printed circuit board 120. Thus, signals can be exchanged between the transceiver device 110, the pluggable connector 130 and the port device 140 through the electrical signal paths provided by the printed circuit board 120. Port device 140 is configured to receive a terminating end of a transmission cable to convey signals conforming to the 10GBASE-T standard between transceiver device 110 of 10GBASE-T X2 module 100 and a network device (not shown). Thus, 10GBASE-T X2 module 100 serves as an interface to enable data communication and signal exchange between network devices and system devices operating under the 10GBASE-T standard while conforming to the pluggable X2 form factor.

Referring again to FIG. 1, 10GBASE-T X2 module 100 further includes an upper housing member 150 that covers the portion of the top side of printed circuit board 120 on which is mounted transceiver device 110 and port device 140. Upper housing member 150 is constructed of a thermally conductive material and can operate as a heat sink for module 100. In particular, when assembled, upper housing member 150 is in direct contact with transceiver device 110 and port device 140 and optionally is also in direct contact with at least portions of printed circuit board 120 to dissipate heat from these components via conduction. To increase surface area and enhance heat dissipation to the surrounding environment, external fins 152 that extend transversely across an outer surface of upper housing member 150 can be included. In operation, upper housing member 150 dissipates sufficient heat to enable 10GBASE-T X2 module 100 to remain below a thermal threshold required for operation (e.g., 75° C.).

Upper housing member 150 is coupled to a lower housing member 160, serving as a bottom casing of module 100, by screws 162 to form a substantially enclosed housing that encases all of printed circuit board 120 except the longitudinal end on which is arranged pluggable connector 130. Printed circuit board 120 is affixed to lower housing member 160 via latches 164.

As described in greater detail below, a portion of port device 140 extends beyond one end of printed circuit board 120 in the longitudinal direction. Just beyond the end of printed circuit board 120, an electromagnetic interference (EMI) gasket 170 is fitted around an outer perimeter of port device 140 in a transverse plane. When assembled, an end wall 154 of upper housing member 150 is situated adjacent to EMI gasket 170. End wall 154 has greater transverse dimensions in width and height than the rest of upper housing member 150, such that a shoulder is formed on the top and sides of upper housing member 150 at the junction with end wall 154.

A port cover 172 surrounds the outmost end of port device 140 in a transverse direction. Port cover 172 has inward extending longitudinal protrusions that are inserted into openings in end wall 154 of upper housing member 150, and port cover 172 is coupled to end wall 154 via springs 174. An outer EMI gasket 176 is situated around upper and lower housing members 150, 160 in a transverse direction at the shoulder of end wall 154.

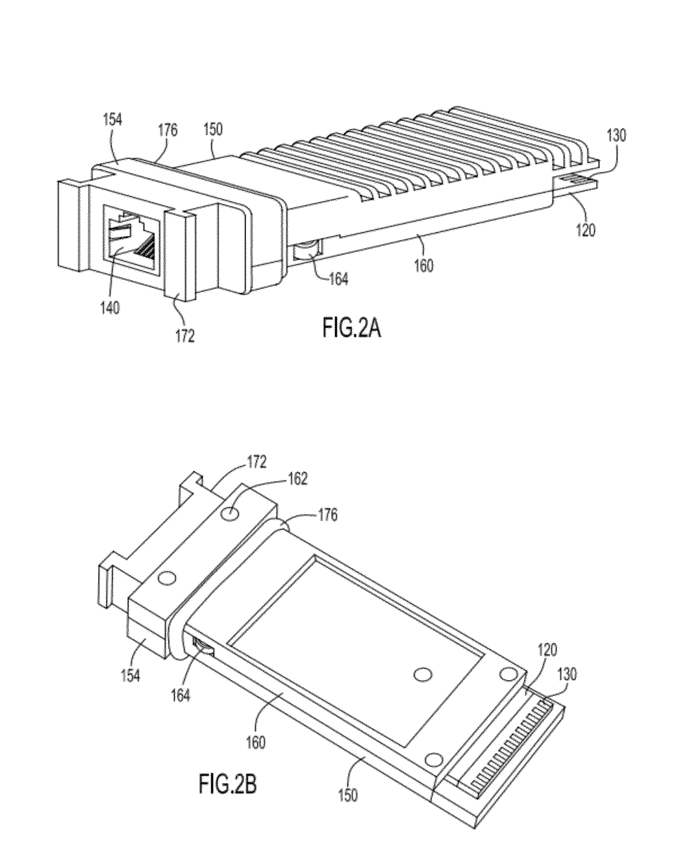

FIGS. 2A and 2B show perspective views of 10GBASE-T X2 form factor module 100 fully assembled. Note that the longitudinal end portion of printed circuit board 120, on which pluggable connector 130 is formed, protrudes from lower housing member 160. As seen in these drawings, pluggable connector 130 includes a plurality of pins (i.e., 70 pins in the X2 form factor) that convey signals between a system device and the transceiver device 110 when inserted into an X2 socket of the system.

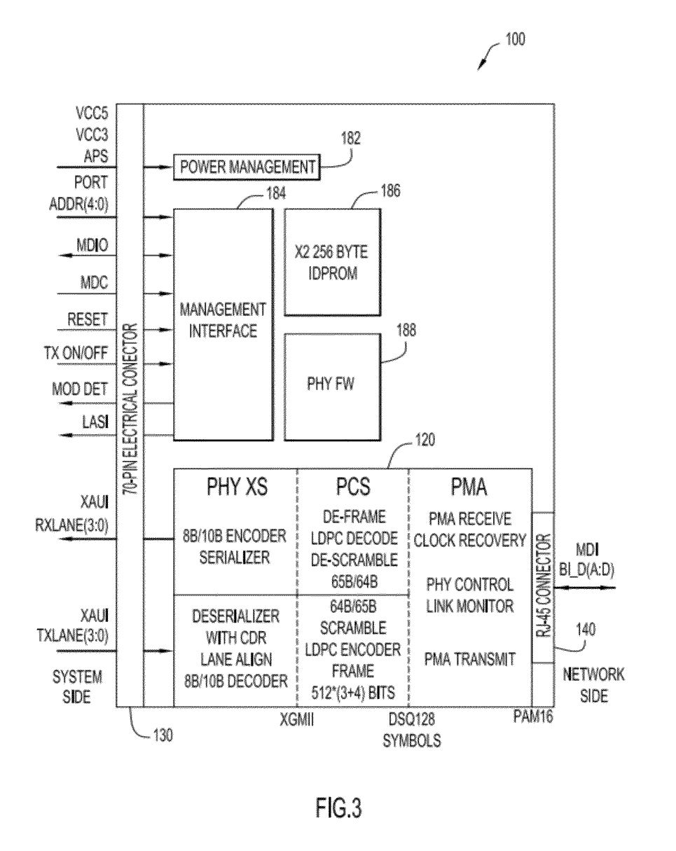

FIG. 3 shows a diagram depicting components of the form factor device 100. The port device 140 is disposed at one end of the form factor device 100, as described above. The port device 140 may interface with a transmission cable coupled to a network device (not shown) to convey signals between the network device and the transceiver device 110. In one example, the port device 140 may be a registered jack (RJ) 45 port that is configured to receive a transmission cable (e.g., an Ethernet cable) to convey signals that comply with the 10GBASE-T standard. The pluggable connector device 130 is disposed at an opposite end of the form factor device 100, as described above. The pluggable connector device 130 is configured to plug into a system port device (not shown) to convey signals between the transceiver device 110 and the system port device. In particular, the pluggable connector device 130 is configured to plug into an X2 system port device to convey signals that comply with the 10GBASE-T standard between the transceiver device 110 and the X2 system port device. When the pluggable connector device 130 is plugged into the X2 system port device, the pluggable connector device 130 can communicate or exchange data signals with the system port device across one or more pins designated for data transmission standards. Specifically, the pluggable connector device 130 has a 70-pin layout that is configured to mate with a 70-pin layout of the X2 system port device. The pins of the pluggable connector device 130 mate with the pins of the X2 system port device, and 10GBASE-T signals are exchanged between the pluggable connector device 130 and the X2 system port device over pins designated for the 10 Gigabit Medium Attachment Unit Interface (i.e., “XAUI”) data communication standard.

FIG. 3 also shows functional components of transceiver device 110. Transceiver device 110 is shown as a physical layer device (“PHY”) having serializers and deserializers, layers (e.g., a physical coding sublayer (“PCS”)) and attachments (e.g., a physical medium attachment (PMA)). Module 100 also includes a power management device 182 that is configured to regulate power consumption of module 100. Additionally, module 100 includes a management interface 184, memory 186, and firmware 188 for operating module 100.

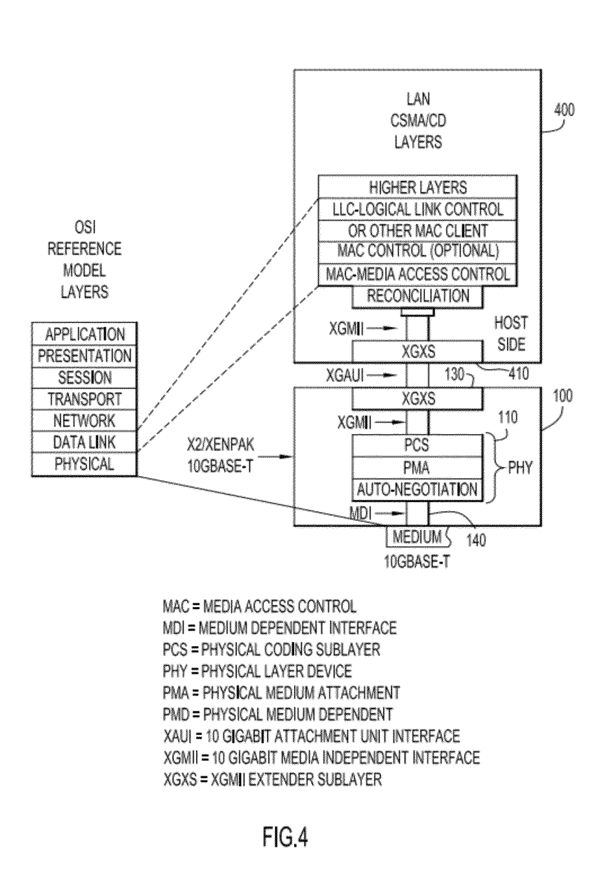

FIG. 4 is a diagram depicting functionality of the 10GBASE-T X2 module 100 in relation to the ISO OSI reference model. As shown in FIG. 4, the pluggable connector 130 of module 100 plugs into a system port device 410 of a system device 400. Pluggable connector 130 may interface with the system port device 410 via one or more signal connection standards. For example, the pluggable connector device 130 may interface with the system port device 410 using the Extended Auxiliary Unit Interface (XAUI) standard. When pluggable connector 130 interfaces or plugs into system port device 410, transceiver device 110 is able to transmit signals received from port device 140 that comply with the 10GBASE-T standard to the system device 400 through pluggable connector 130. Similarly, when pluggable connector 130 plugs into system port device 410, transceiver device 110 is able to transmit signals received from system device 400 that comply with the 10GBASE-T standard to a network device (not shown) that is coupled to port device 140. Thus, signals that comply with the 10GBASE-T standard can be transmitted between a network device coupled to module 100 and an X2 system device 400 that is plugged into module 100.

In order to configure 10GBASE-T X2 module 100 to transmit 10GBASE-T signals between a network device and a system device 400 that is pluggable into module 100, several technical challenges must be overcome. For example, the available power supplied by the system device for operating a pluggable X2 form factor module is limited; accordingly, module 100 must be designed to operate within the available power limit. For example, the maximum available power for operating module 100 is about 5.3 watts. Consequently, the layout of printed circuit board 120, the power consumption of transceiver module 110, and the operation of power management device 122 are designed to ensure power consumption module 100 remains below this level. An adaptive voltage feature may be introduced into module 100 by using, e.g., a DC-DC converter to serve as the power management device 182.

Another technical challenge involves the thermal density of module 100. Pluggable module 100 is required to maintain a temperature below a certain threshold (e.g., 75° C.) to ensure continuous reliable operation. By designing the upper housing member 150 to operate as a heat sink that is in direct contact with transceiver device 110 and port device 140, module 100 can be built within the X2 form factor size requirements while still maintain an acceptable operating temperature while consuming 5.3 Watts.

Yet another technical challenge involves mechanically interfacing module 100 with system device 400. Existing devices are not structured to fit a 10GBASE-T transceiver device 110 onto a printed circuit board within the X2 form factor, as described above. To meet this requirement, module 100 is mechanically arranged to maximize real estate on printed circuit board 120.

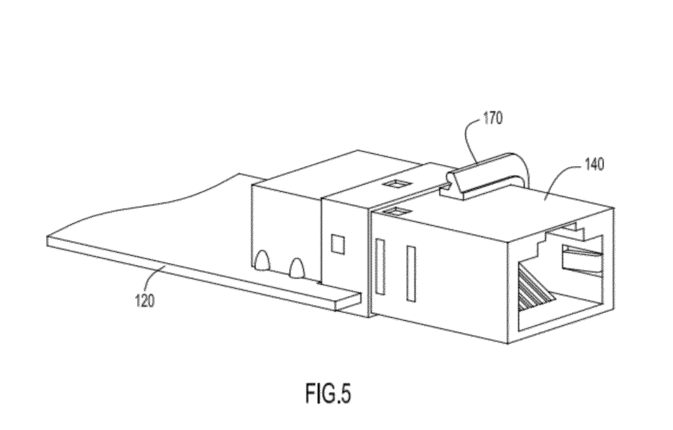

FIG. 5 shows one such mechanical design feature involving port device 140. In particular, if a standard RJ-45 connector were to be mounted on the top surface of printed circuit board 120, the overall height of module 100 would exceed the height requirements for a pluggable X2 form factor module. To keep the overall height within the form factor requirements, port device 140 includes a slot that receives printed circuit board 120, allowing about half of port device 140 to extend around (over and under) printed circuit board 120, with the other half of port device 140 extending past the edge of printed circuit board. As shown in FIG. 5, the slot extends completely through port device 140 from one side surface to another and extends from a rear surface of port device 140 to a point near the center of port device 140. When the printed circuit board is inserted, the port device 140 straddles the printed circuit board 120 such that a portion of port device 140 lies above the top surface of printed circuit board 120 and a portion of port device 140 lies below the bottom surface of printed circuit board 120, thereby reducing the height displacement of port device 140 relative to a similar port device with its bottom surface mounted on the top surface of the printed circuit board.

In sum, an apparatus is provided comprising: a printed circuit board, a transceiver device mounted on the printed circuit board and configured to transmit and receive signals that comply with a 10GBASE-T standard, a pluggable connector disposed at one end of the printed circuit board and coupled to the transceiver device, the pluggable connector being configured to plug into an X2 form-factor host port to convey signals that comply with the 10GBASE-T standard between the transceiver device and a system device, and a port device disposed at an opposing end of the printed circuit board and coupled to the transceiver device, the port device being configured to receive a transmission cable to convey signals that comply with the 10GBASE-T standard between the transceiver device and a network device.

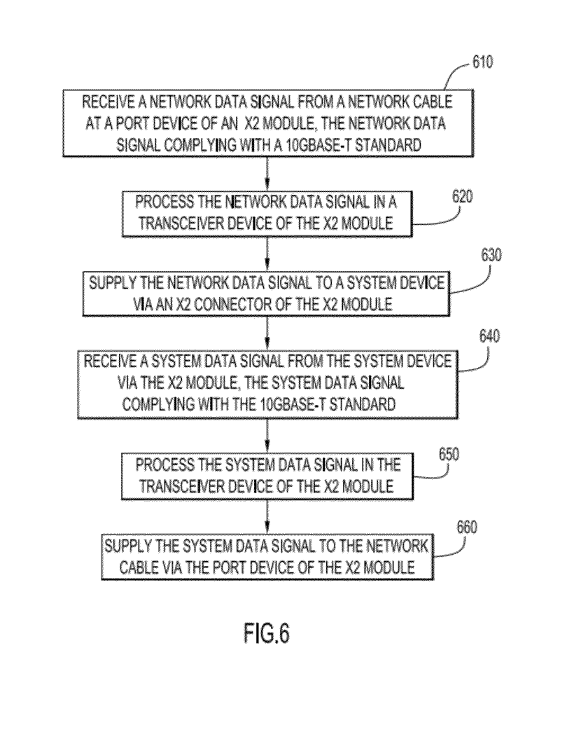

FIG. 6 is a functional flow diagram summarizing operations performed to convey signals between a system device and network device via the 10GBASE-T X2 module. In operation 610, a network data signal complying with a 10GBASE-T standard is received from a network cable at a port device of an X2 module. In operation 620, the network data signal is processed in a transceiver device of the X2 module, and in operation 630, the network data signal is supplied to a system device via an X2 form factor pluggable connector of the X2 module. For a system data signal travelling from a system device to a network device, in operation 640, the system data signal is received from the system device via the X2 form factor pluggable connector of the X2 module. The system data signal is processed in the transceiver device of the X2 module (operation 650) and the system data signal is supplied to the network cable via the port device of the X2 module (operation 660).

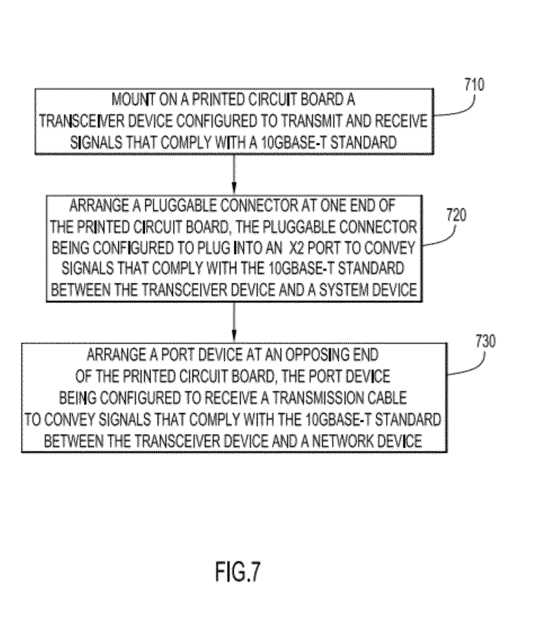

FIG. 7 is a functional flow diagram summarizing operations performed to manufacture a 10GBASE-T X2 transceiver module. In operation 710, a transceiver device configured to transmit and receive signals that comply with a 10GBASE-T standard is mounted on a printed circuit board. In operation 720, a pluggable connector is arranged at one end of the printed circuit board, where the pluggable connector is configured to plug into an X2 host port to convey signals that comply with the 10GBASE-T standard between the transceiver device and a system device. In operation 730, a port device is arranged at an opposing end of the printed circuit board, where the port device is configured to receive a transmission cable to convey signals that comply with the 10GBASE-T standard between the transceiver device and a network device.

The above description is intended by way of example only. Various modifications and structural changes may be made therein without departing from the scope of the concepts described herein and within the scope and range of equivalents of the claims.

What is claimed is:

1. An apparatus comprising:
a printed circuit board;
a transceiver device mounted on the printed circuit board and configured to transmit and receive signals that comply with a 10GBASE-T standard;
an X2 form factor pluggable connector disposed at one end of the printed circuit board, the pluggable connector being configured to plug into an X2 host port to convey signals that comply with the 10GBASE-T standard between the transceiver device and a system device; and
a port device disposed at an opposing end of the printed circuit board, the port device being configured to receive a transmission cable to convey signals that comply with the 10GBASE-T standard between the transceiver device and a network device.

2. The apparatus of claim 1, further comprising a housing in communication with the printed circuit board, the transceiver device, and the port device, the housing comprising a heat sink configured to dissipate heat.

3. The apparatus of claim 2, wherein an outer surface of the housing comprises a plurality of fins.

4. The apparatus of claim 1, wherein the port device is configured to receive an Ethernet transmission cable configured to carry signals that comply with the 10GBASE-T standard.

5. The apparatus of claim 1, further comprising a power management device mounted on the printed circuit board, wherein the power management device is configured to maintain power consumption of the apparatus below 5.3 Watts.

6. The apparatus of claim 1, wherein the port device includes a slot that receives the printed circuit board such that a portion of the port device lies above a top surface of the printed circuit board and a portion of the port device lies below a bottom surface of the printed circuit.

7. The apparatus of claim 6, wherein the port device comprises a registered jack (RJ) 45 connector.

8. A method comprising:
receiving a network data signal from a network cable at a port device of an X2 form factor pluggable module, the network data signal complying with a 10GBASE-T standard;
processing the network data signal in a transceiver device of the module;
supplying the network data signal to a system device via an X2 form factor pluggable connector of the module;
receiving a system data signal from the system device via the X2 form factor pluggable connector of the module, the system data signal complying with the 10GBASE-T standard;
processing the system data signal in the transceiver device of the module; and
supplying the system data signal to the network cable via the port device of the module.

9. The method of claim 8, further comprising maintaining power consumption of the module below 5.3 watts.

10. A method comprising:
mounting on a printed circuit board a transceiver device configured to transmit and receive signals that comply with a 10GBASE-T standard;
arranging an X2 form factor pluggable connector at one end of the printed circuit board, the pluggable connector being configured to plug into an X2 port to convey signals that comply with the 10GBASE-T standard between the transceiver device and a system device; and
arranging a port device at an opposing end of the printed circuit board, the port device being configured to receive a transmission cable to convey signals that comply with the 10GBASE-T standard between the transceiver device and a network device.

11. The method of claim 10, further comprising coupling a housing to the printed circuit board, the transceiver device, and the port device, wherein the housing comprises a heat sink configured to dissipate heat.

12. The method of claim 11, further comprising forming the housing to include a plurality of fins.

13. The method of claim 10, further comprising forming the port device to receive an Ethernet transmission cable configured to carry signals that comply with the 10GBASE-T standard.

14. The method of claim 10, further comprising mounting a power management device on the printed circuit board, wherein the power management device is configured to maintain power consumption of the apparatus below 5.3 watts.

15. The method of claim 10, further comprising forming the port device with a slot that receives the printed circuit board such that a portion of the port device lies above a top surface of the printed circuit board and a portion of the port device lies below a bottom surface of the printed circuit board.

16. The method of claim 15, further comprising forming the port device as a registered jack (RJ) 45 connector to the printed circuit board.
